(19) United States
(12) Patent Application Publication
(10) Pub. No.: US 2010/0260284 A1
(43) Pub. Date: Oct. 14, 2010

(54) PILOT TRANSMISSION METHOD, MIMO TRANSMISSION DEVICE, AND MIMO RECEPTION DEVICE

(75) Inventors: Isamu Yoshii, Kanagawa (JP); Atsushi Sumasu, Kanagawa (JP); Tomohiro Imai, Kanagawa (JP); Hidenori Kayama, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/742,894

(22) PCT Filed: Dec. 9, 2008
(86) PCT No.: PCT/JP2008/003670

§ 371 Date: May 13, 2010

(30) Foreign Application Priority Data
Dec. 10, 2007 (JP) 2007-316748

(51) Int. Cl. H04L 27/00

(52) U.S. Cl. 375/295

(57) ABSTRACT

Provided is a MIMO transmission device which can effectively perform a pilot transmission by using a surplus sample generated in a pilot symbol while maintaining the pilot separation accuracy at a reception side. The MIMO transmission device (100) transmits a pilot symbol as follows. That is, in a first pilot transmission symbol section, a transmission section of a pilot signal transmitted from a first transmission antenna is partially overlapped by a pilot transmission section of a second transmission antenna. In a second pilot transmission symbol section, a pilot transmission section of the first transmission antenna is partially overlapped by a pilot transmission section of a third antenna. Among the pilot signals transmitted from the first antenna, the interference portions overlapped by transmission pilot signals from other antennas are different between the first pilot transmission symbol section and the second pilot transmission symbol section.

### TECHNICAL FIELD

The present invention relates to a pilot transmission method, a MIMO transmission apparatus and a MIMO reception apparatus.

### BACKGROUND ART

In recent years, MIMO (Multiple-Input/Multiple-Output) communication is attracting attention as a technology to allow communication of large volume of data such as images. With this MIMO communication, a plurality of antennas on the transmitting side transmit different transmission data (substreams) and received data formed by mixing a plurality of transmission data on channels is separated into the original transmission data on the receiving side. When this separation processing is performed, channel estimation values are required.

Patent Document 1 discloses a method of channel estimation in a MIMO communication system (OFDM-MIMO communication system) adopting the OFDM (Orthogonal Frequency Division Multiplexing) system.

On the MIMO transmission apparatus side of the OFDM-MIMO communication system disclosed in Patent Document 1, first, an OFDM symbol (hereinafter may be referred to as “pilot OFDM symbol”) is formed by signal sequences generated in the pilot signal sequence generating section as shown in FIG. 1. In this pilot OFDM symbol, the same signal is superimposed on all subcarriers, and therefore the pilot OFDM appears an impulse in the time domain.

Then, these pilot OFDM symbols are subjected to cyclic shift processing with different shift amounts per antenna, attached cyclic prefixes (CPs), and transmitted from a plurality of antennas.

Here, the cyclic shift processing is processing to move the part corresponding to k samples from the end of a pilot OFDM symbol to the beginning of that OFDM symbol and sequentially shift parts other than this moved part k samples backward. That is, the beginning position of a pilot OFDM symbol before cyclic shift processing (hereinafter may be referred to as “initial first position”) is shifted k samples backward after cyclic shift processing.

Therefore, although the MIMO transmission apparatus in FIG. 1 transmits pilot OFDM symbols from two antennas at the same timing, the initial first position is shifted k samples in the OFDM symbols (see FIG. 3).

On the MIMO reception apparatus side of the OFDM-MIMO communication system, a range of k samples from the initial first position in a pilot OFDM symbol is actually used as “pilot.” Therefore, the MIMO transmission apparatus shifts pilots by k samples in the time domain between antennas by applying cyclic shift processing to pilot OFDM symbols. Here, in order to prevent interference between pilot OFDM symbols transmitted from different antennas, k samples are practically set equal to or more than the maximum multipath delay time.

After receiving each pilot OFDM symbol transmitted as described above, the MIMO reception apparatus first removes the CPs. Then, MIMO reception apparatus extracts the first k-sample part and the subsequent parts from each received pilot OFDM symbol without CPs. That is, the MIMO reception apparatus performs separating processing of pilots transmitted from respective transmitting antennas on the assumption that the first k-sample part is the multipath of transmitting antenna 1 and the subsequent parts are the multipath of antenna 2. FFT processing is performed on both sampled parts. This processing is performed per receiving antenna of the MIMO reception apparatus. Then, the results of FFT processing calculated for all combinations of transmitting antennas and receiving antennas are used to calculate channel estimation values.
Patent Document 1: Japanese Patent Application Laid-Open No. 2007-20072

### DISCLOSURE OF INVENTION

### Problems to be Solved by the Invention

Here, a sample length to which transmitting antennas are allocated, that is, the above-described k samples, is determined in accordance with the maximum delay time under the limitation that k samples are equal to or shorter than an OFDM symbol.

Since there is no correlation between an OFDM symbol length and the maximum delay time, there are “remaining samples (time domain)” in an OFDM symbol if k samples determined in accordance with the maximum delay time are arranged in the OFDM symbol without overlapping. Since these remaining samples are shorter than the maximum delay time, with the above-described MIMO transmission apparatus, there are parts not allocated to the pilots transmitted from other antennas, that is, parts carrying no information available to the receiving side in a pilot symbol.

It is therefore an object of the present invention to provide a pilot transmission method and a MIMO transmission apparatus allowing efficient pilot transmission utilizing remaining samples present in pilot symbols while maintaining the accuracy of pilot separation on the receiving side, and a MIMO reception apparatus being capable of receiving pilots transmitted from the MIMO transmission apparatus and separating pilots accurately.

### Means for Solving the Problem

The pilot transmission method according to the present invention is a method of transmitting pilots in a multiple-input/multiple-output transmission apparatus that transmits pilots from a plurality of transmitting antennas and has a configuration including the steps of: generating pilot signal sequences including the pilots as part of the sequences; and transmitting the pilot signal sequences with the pilots at transmission timings shifted between the plurality of transmitting antennas by cyclic-shifting the pilot signal sequences in each pilot transmission symbol period. The transmission timings of the pilots differ between a first pilot transmission symbol period and a second pilot transmission symbol period.

The MIMO transmission apparatus according to the present invention has a configuration including: a plurality of transmitting antennas that transmit pilot signal sequences including pilots as part of the sequences in pilot transmission symbol periods, respectively; and a pilot transmission section that comprises a cyclic shift section which shifts transmission timings of the pilots between the plurality of transmitting antennas for cyclic-shifting the pilot signal sequences, and selects transmitting antennas for the pilot signal sequences for each pilot transmission symbol period. The pilot transmission section changes the transmission timings of the pilots between a first pilot transmission symbol period and a second pilot transmission symbol period.

The MIMO reception apparatus according to the present invention is a multiple-input/multiple-output reception apparatus that receives a first pilot symbol and a second pilot symbol transmitted such that interfering parts of pilots transmitted from a first transmitting antenna with overlap with transmission periods for pilots transmitted from other transmitting antennas other than the first transmitting antenna change between a first pilot transmission symbol period and a second pilot transmission symbol period and has a configuration including: a delay profile creating section that creates a first delay profile and a second delay profile from the first pilot symbol and the second pilot symbol received; a delay profile reproducing section that samples, in the first and second delay profiles, first and second partial delay profiles corresponding to non-interfered parts of the pilots transmitted from the first transmitting antenna, and combines the first and second partial delay profiles to form a combined delay profile; a calculating section that subtracts the combined delay profile from the delay profiles; and a channel estimation value calculating section that calculates a channel estimation value based on the combined delay profile and a subtraction result in the calculating section.

### Advantageous Effects of Invention

The present invention can provide a pilot transmission method and a MIMO transmission apparatus allowing efficient pilot transmission utilizing remaining samples present in pilot symbols while maintaining the accuracy of pilot separation on the receiving side, and a MIMO reception apparatus being capable of receiving pilots transmitted from the MIMO transmission apparatus and separating pilots accurately.

### BRIEF DESCRIPTION OF DRAWINGS

FIG. 1 is a drawing explaining a conventional OFDM-MIMO communication system;

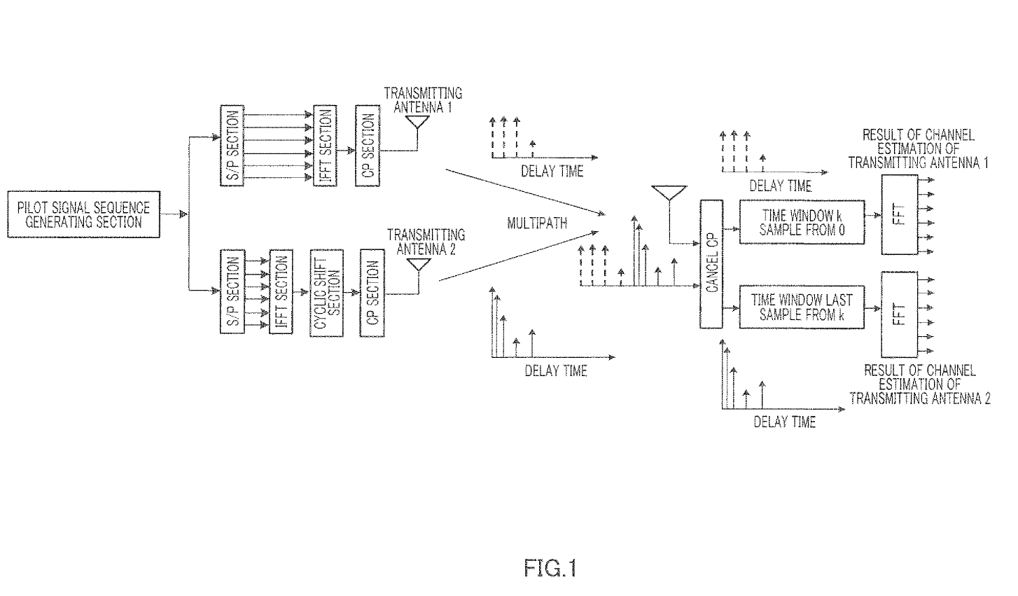

FIG. 2 is a drawing explaining cyclic shift processing;

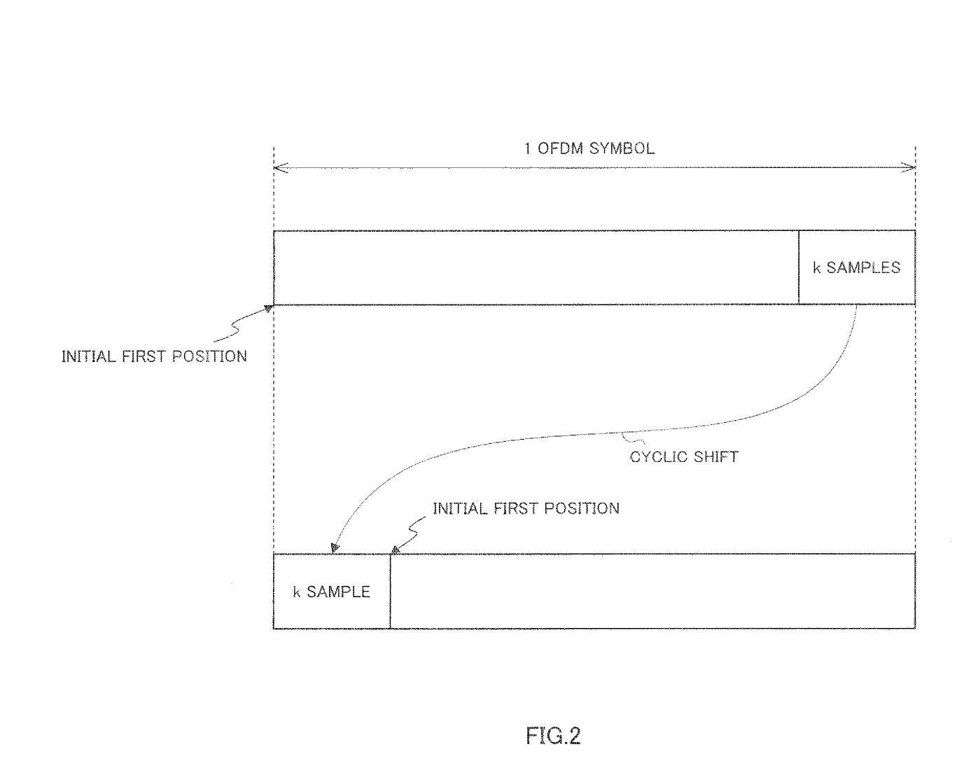

FIG. 3 is a drawing explaining pilot transmission of a conventional MIMO transmission apparatus;

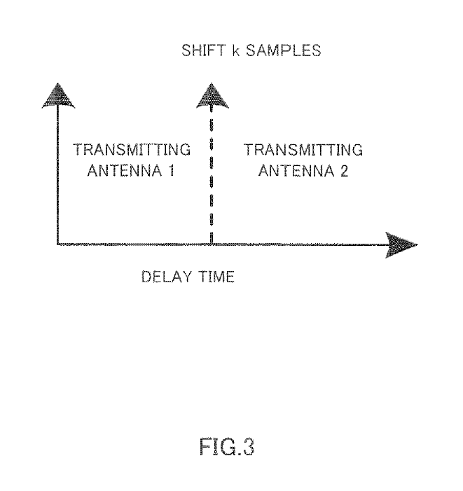

FIG. 4 is a block diagram showing a configuration of a MIMO transmission apparatus according to embodiment 1 of the present invention;

FIG. 5 is a block diagram showing a configuration of a MIMO reception apparatus according to embodiment 1;

FIG. 6 is a drawing explaining operations of the MIMO transmission apparatus in FIG. 4;

FIG. 7 is a drawing explaining operations of the MIMO transmission apparatus in FIG. 4 and the MIMO reception apparatus in FIG. 2;

FIG. 8 is a drawing explaining operations of the MIMO transmission apparatus in FIG. 4 and the MIMO reception apparatus in FIG. 2;

FIG. 9 is a drawing explaining creation and extraction processing of delay profiles in the MIMO reception apparatus in FIG. 5;

FIG. 10 is a drawing explaining creation and extraction processing of delay profiles in the MIMO reception apparatus in FIG. 5;

FIG. 11 is a drawing explaining combining processing of partial delay profiles in the MIMO reception apparatus in FIG. 5;

FIG. 12 is a drawing explaining combining processing of partial delay profiles in a MIMO reception apparatus according to embodiment 2; and

FIG. 13 is a drawing explaining operations of a MIMO transmission apparatus according to embodiment 3 of the present invention.

### BEST MODE FOR CARRYING OUT THE INVENTION

Now, embodiments of the present invention will be described in detail with reference to the accompanying drawings. Here, the same components in embodiments will be assigned the same reference numerals and overlapping descriptions will be omitted.

### Embodiment 1

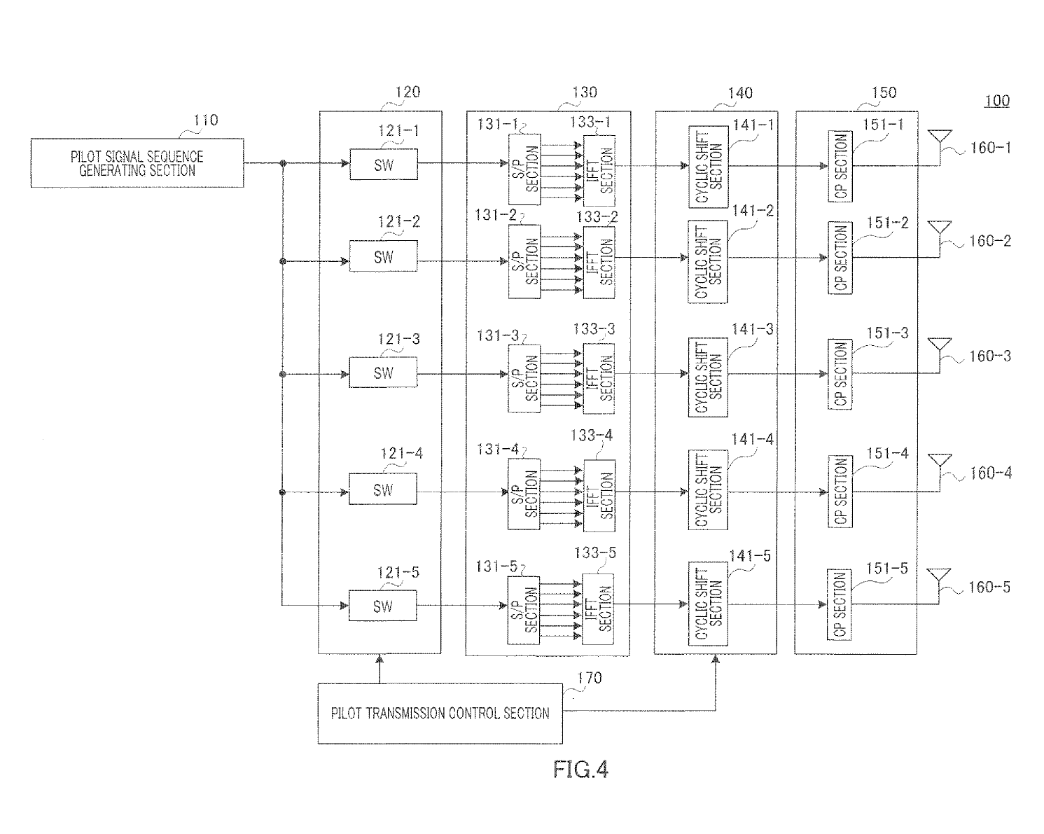

As shown in FIG. 4, MIMO transmission apparatus 100 in the MIMO-OFDM communication system according to the present embodiment has pilot signal sequence generating section 110, switch section 120, OFDM signal generating section 130, cyclic shift processing section 140, CP adding processing section 150, transmitting antennas 160-1 to N (here, N=5) and pilot transmission control section 170.

Pilot signal sequence generating section 110 generates pilot signal sequences including pilots as part of the sequences and outputs them to switch section 120. Pilot signal sequence generating section 110 outputs pilot signal sequences in accordance with symbol timings.

Switch section 120 has switches (SWs) 121-1 to 5 that control to input pilot signal sequences to transmission systems respectively corresponding to antennas 160-1 to 5. The branch numbers correspond to the numbers of transmission systems. Switch section 120 turns on and off SWs 121 based on transmission control information from pilot transmission control section 170. Switch section 120 turns on the SW 121 ordered to be turned on through the transmission control information, while keeping the other SWs 121 turned off, which are not ordered to be turned on.

OFDM signal generating section 130 has S/P sections 131-1 to 5 and IFFT sections 133-1 to 5. OFDM signal generating section 130 has a set of S/P section 131 and IFFT section 133 corresponding to each transmission system.

OFDM signal generating section 130 inputs pilot signal sequences per transmission system. OFDM signal generating section 130 forms a pilot OFDM symbol by serial-parallel converting the inputted pilot signal sequences and then inverse Fourier transforming the result. OFDM signal generating section 130 outputs the formed pilot OFDM symbol to cyclic shift processing section 140 per transmission system.

Cyclic shift processing section 140 has cyclic shift sections 141-1 to 5 corresponding to transmission systems, respectively. Cyclic shift processing section 140 receives a pilot OFDM symbol per transmission system as input. Cyclic shift processing section 140 cyclic shifts the inputted pilot OFDM symbol based on cyclic shift control information inputted from pilot transmission control section 170. Cyclic shift processing section 140 outputs the pilot OFDM symbol after cyclic shift to CP adding processing section 150.

CP adding processing section 150 has CP sections 150-1 to 5 corresponding to transmission systems, respectively. CP adding processing section 150 receives a pilot OFDM symbol after cyclic shift as input per transmission system and adds a CP to that. The pilot OFDM symbol with a CP is transmitted from antenna 160 per transmission system.

Pilot transmission control section 170 controls transmission timings of pilot signal sequences by outputting transmission control information to SWs 121 at transmission timings (in pilot transmission symbol periods). The transmission control information outputted at each transmission timing includes on-command information indicating SW 121 to be turned on at that timing. Thus, pilot transmission control section 170 controls transmission timings of pilot signal sequences and control of switching the transmission system that transmits pilot signal sequences at each transmission timing.

In addition, pilot transmission control section 170 controls the amount of cyclic shift in each cyclic shift section 141 by outputting cyclic shift control information to cyclic shift processing section 140.

Here, only part of pilot signal sequences, that is, only pilot parts are used to calculate channel estimation values on the receiving side, as described later. The transmission timing to transmit pilots from each transmission system is adjusted by allocating different amounts of cyclic shifting to transmission systems in pilot transmission control section 170.

With the present embodiment, pilot transmission control section 170 controls pilot transmission such that: in a first pilot transmission symbol period, the transmission period for pilots transmitted from a first antenna (hereinafter may be referred to as “interfering pilots”) and the transmission period for pilots transmitted from a second antenna partially overlap; in a second pilot transmission symbol period, the transmission period for pilots transmitted from the first antenna and the transmission period for pilots transmitted from a third antenna partially overlap; and part of pilots transmitted from the first antenna with overlap with pilots transmitted from other antennas changes between the first pilot transmission symbol period and the second pilot transmission symbol period. Here, although the first and second pilot transmission symbol periods will be described as two consecutive OFDM symbol periods at the beginning of a subframe, the arrangement of pilot OFDM symbols in a frame is not limited to this.

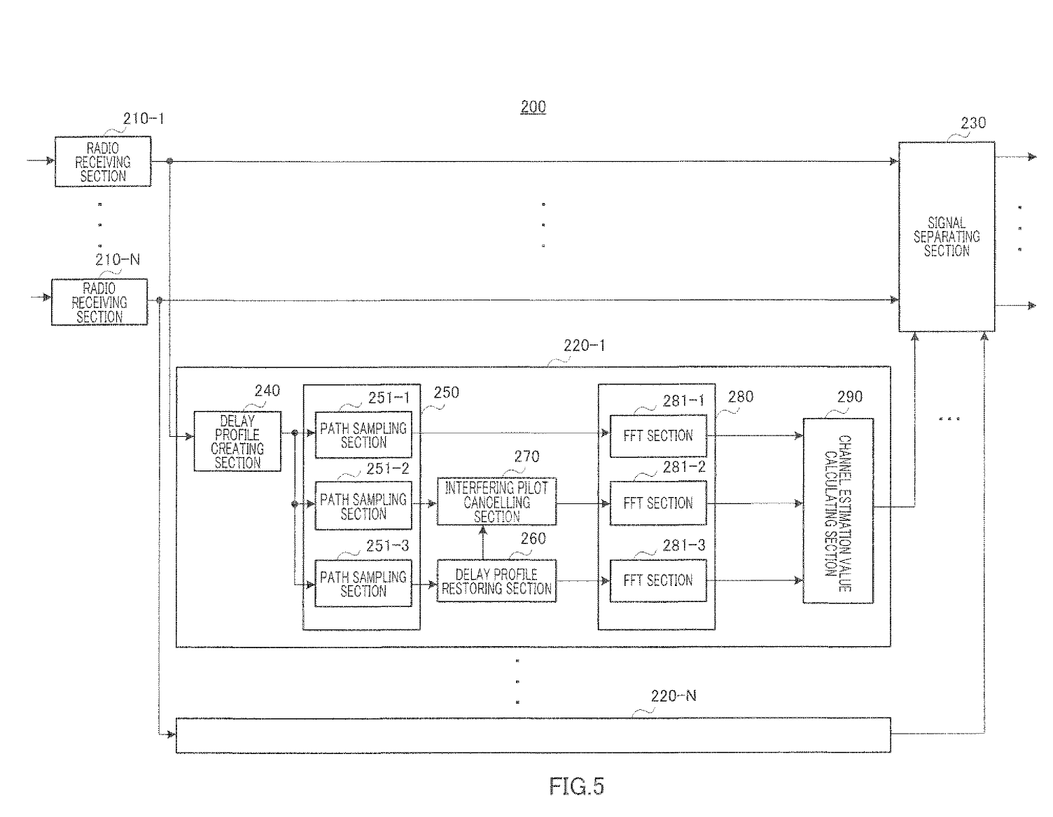

As shown in FIG. 5, MIMO reception apparatus 200 in the MIMO-OFDM communication system according to the present embodiment has radio receiving sections 210-1 to N corresponding to N receiving antennas (not shown), respectively, channel estimating sections 220-1 to N and signal separating section 230.

Radio receiving sections 210-1 to N perform predetermined radio receiving processing (e.g., down-conversion and A/D conversion) on received signals received by corresponding receiving antennas, respectively, remove the CPs and send the obtained signals to respectively corresponding channel estimating sections 220-1 to N and signal separating section 230.

Channel estimating sections 220-1 to N receive receiving OFDM signals from corresponding radio receiving sections 210 to N, respectively, and calculate channel estimation values using pilots included in these received OFDM signals. Each of channel estimating sections 220-1 to N calculates a channel estimation value relating to the subcarrier between the corresponding receiving antenna and each transmitting antenna of MIMO transmission apparatus 100.

To be more specific, channel estimating section 220 has delay profile creating section 240, path sampling processing section 250, delay profile restoring section 260, interfering pilot cancelling section 270, FFT processing section 280 and channel estimation value calculating section 290.

Delay profile creating section 240 creates a delay profile from the OFDM signal received as input.

Path sampling processing section 250 samples a pilot OFDM symbol part in the delay profile. To be more specific, path sampling processing section 250 extracts, from a delay profile, samples corresponding to: “non-interfered pilots” transmitted without overlapping with pilots from other antennas on the transmitting side; pilots transmitted in the transmission period partially overlapping with interfering pilots (hereinafter these may be referred to as “interfered pilots” and interfering pilots; and part of interfering pilots not overlapping with interfered pilots (hereinafter these may be referred to as “non-interfered parts”) in each pilot OFDM symbol.

To be more specific, path sampling processing section 250 has path sampling sections 251-1 to 3.

Path sampling section 251-1 extracts the sample corresponding to the non-interfered pilot in each pilot OFDM symbol using a preset time window. The time window of path sampling section 251-1 corresponds with the period in which the non-interfered pilot is placed by the transmission side, in a pilot OFDM symbol (the time frame equivalent to the above-described k samples). Then, when a plurality of non-interfered pilots in one pilot OFDM symbol are transmitted from the transmission side, path sampling section 251-1 samples each non-interfered pilot using the time window.

Path sampling section 251-2 extracts samples corresponding to both the interfered pilot and the interfering pilot in each pilot OFDM symbol using a preset time window. The time window of path sampling section 251-2 corresponds with the period in a pilot OFDM symbol in which both the interfered pilot and the interfering pilot are placed by the transmission side.

Path sampling section 251-3 extracts samples corresponding to part of the non-interfered pilots in each pilot OFDM symbol not overlapping with the interfering pilots using a preset time window. The time window of path sampling section 251-3 corresponds with the period in a pilot OFDM symbol in which part of the interfering pilots not overlapping with the interfered pilot is placed by the transmission side.

Delay profile restoring section 260 forms delay profiles obtained when interfering pilots are transmitted without overlapping with transmission timings of other pilots using non-interfered parts of two interfering pilots sampled in two pilot OFDM symbols. That is, delay profile restoring section 260 combines partial delay profiles of non-interfered parts sampled in path sampling processing section 250 to form an overall delay profile (combined delay profile).

Interfering pilot cancelling section. 270 subtracts the delay profile formed in delay profile restoring section 260 from delay profiles respectively corresponding to the interfered pilot and the interfering pilot sampled in path sampling processing section 250. By this means, it is possible to cancel interfering components to obtain delay profiles including only interfered pilots.

FFT processing section 280 receives, as input, delay profiles of non-interfered pilots sampled in path sampling processing section 250, delay profiles of interfering pilots formed in delay profile restoring section 260 and delay profiles of interfered pilots obtained in interfering pilot cancelling section 270. FFT processing section 280 performs Fourier transform processing on each pilot delay profile received as input. Here, FFT processing section 280 has FFT sections 281-1 to 3 corresponding to path sampling processing section 250, interfering pilot cancelling section 270 and delay profile restoring section 260, respectively.

Channel estimation value calculating section 290 calculates channel estimation values using FFT processing results obtained in FFT processing section 280.

Signal separating section 230 separates a received OFDM signal into a plurality of transmission streams included in the received OFDM signal using channel estimation values corresponding to all combinations of transmitting antennas, receiving antennas and subcarriers obtained in channel estimating section 220-1 to N.

Now, operations of MIMO transmission apparatus 100 and MIMO reception apparatus 200 in the MIMO-OFDM communication system having the above-described configuration will be described.

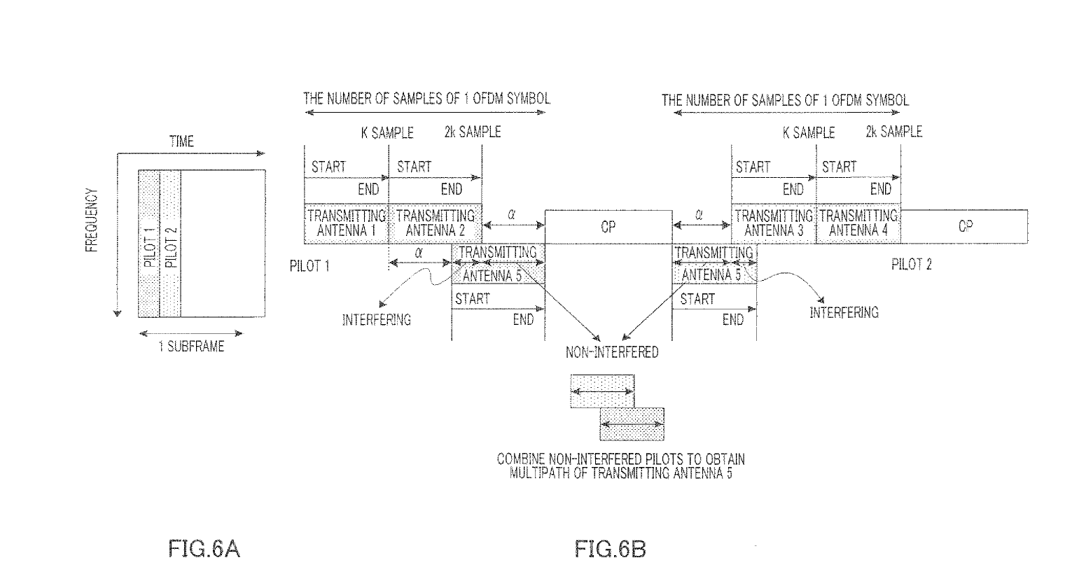

MIMO transmission apparatus 100 transmits pilots from each antenna using two OFDM symbols at the beginning of a subframe as shown in FIG. 6A. In FIG. 6A, pilots transmitted through the beginning OFDM symbol (first pilot transmission symbol period) are pilots 1 and pilots transmitted through the subsequent OFDM symbol (second pilot transmission symbol period) are pilots 2.

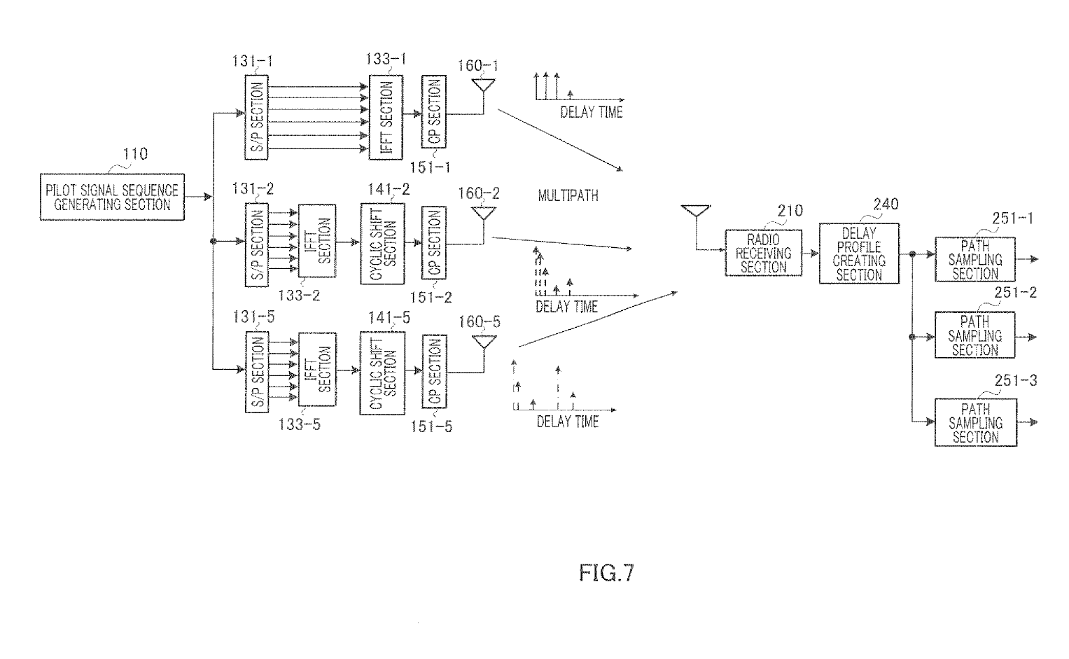

When each pilot transmission symbol period is observed, first, in the first pilot transmission symbol period, pilot signal sequences are inputted to transmission systems of antennas 160-1, 2, and 5 as shown in FIG. 7 by control through pilot transmission control section 170 and are subjected to cyclic shifting processing with shift amounts varying between transmission systems. Among components of MIMO transmission apparatus 100, components involved in pilot transmission in the first pilot transmission symbol period are shown in FIG. 7.

To be more specific, as seen by FIG. 6B, the amount of shift in cyclic sift section 141-1 is 0, the amount of shift in cyclic shift section 141-2 is k samples and the amount of shift in cyclic shift section 141-5 is k+α. That is, as for the initial first position of a pilot signal sequence, it does not change in the pilot signal sequence transmitted from antenna 160-1, it shifts k samples backward in the pilot signal sequence transmitted from antenna 160-2 and it shifts further α samples backward in the pilot signal sequence transmitted from antenna 160-5.

As described later, since MIMO reception apparatus 200 on the receiving side forms delay profiles of interfering pilots using two non-interfered parts transmitted through two OFDM symbols, α is an integer to satisfy “α is k/2 or above and less than k.” Here, pilots transmitted from antenna 1 are non-interfered pilots, pilots transmitted from antenna 2 are interfered pilots and pilots transmitted from antenna 5 are interfering pilots. In addition, with the present embodiment, since all remaining samples are used to transmit interfering pilots, a equals remaining samples.

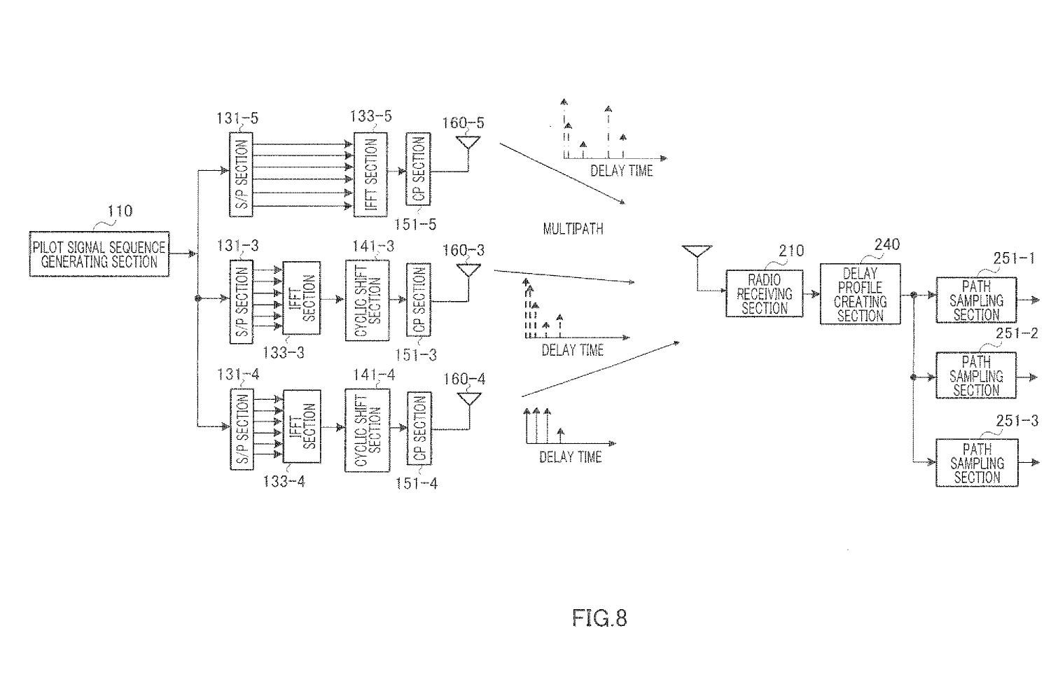

Moreover, in the second pilot transmission symbol period, pilot signal sequences are inputted to transmission systems of antennas 160-3, 4, and 5 as shown in FIG. 8 by control through pilot transmission control section 170 and are subjected to cyclic shifting processing with shift amounts varying between transmission systems.

To be more specific, the amount of shift in cyclic shift section 141-5 is 0, the amount of shift in cyclic shift section 141-3 is a sample and the amount of shift in cyclic shift section 141-4 is k+α. As described later, since MIMO reception apparatus 200 on the receiving side forms delay profiles of interfering pilots using two non-interfered parts transmitted through two OFDM symbols, α is an integer to satisfy “α is k/2 or above and less than k”

As described above, MIMO transmission apparatus 100 transmits pilots through two consecutive OFDM symbols. In addition, the non-interfered part of an interfering pilot, which is placed in a remaining sample, differs between OFDM symbols. Here, the second half part of an interfering pilot is placed in the remaining sample in the first pilot transmission symbol period, and the first half part of the interfering pilot is placed in the remaining sample in the second pilot transmission symbol period. In addition, MIMO transmission apparatus 100 transmits interfering pilots immediately before and after a CP. Moreover, interfered pilots differ depending on OFDM symbols. Moreover, combinations of shift amounts given to pilot signal sequences in an OFDM symbol differ between two consecutive pilot OFDM symbols. That is, transmission timings of pilots differ between two pilot transmission symbol periods.

Pilots transmitted as described above go through a plurality of paths as shown in FIG. 7 and then are received in MIMO reception apparatus 200.

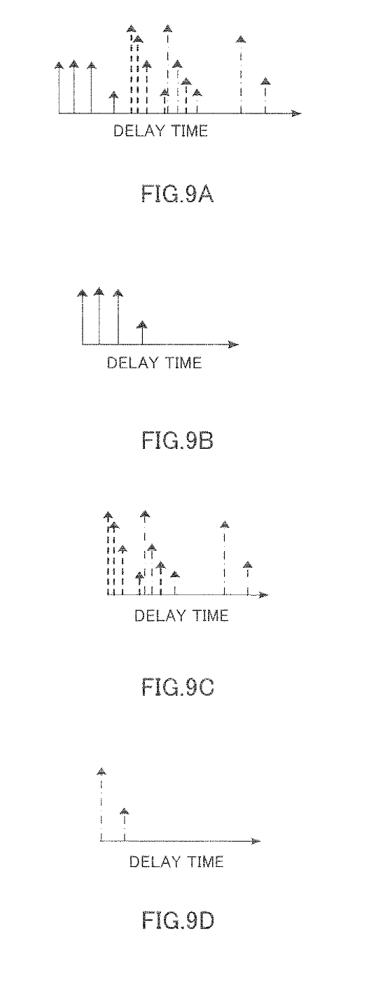

MIMO reception apparatus 200 first performs processing of pilots transmitted in the first pilot transmission symbol period. That is, after performing radio receiving processing on received signals and removing the CPs from the processed signals, MIMO reception apparatus 200 creates delay profiles in delay profile creating section 240. The delay profile obtained at this time is shown in FIG. 9A. The arrows indicated by solid lines correspond to the paths of pilots transmitted from antenna 1, the arrows indicated by bold dashed lines correspond to the paths of pilots transmitted from antenna 2 and the arrows indicated by alternate long and short dash lines correspond to the paths of pilots transmitted from antenna 5.

Then, pilots from antenna 1 are sampled through a time window of k samples in path sampling section 251-1 (see FIG. 9B). In addition, pilots from antenna 2 and antenna 5 are sampled through a time window of k+α samples in path sampling section 251-2 (see FIG. 9C). Moreover, the non-interfered parts of pilots from antenna 5 are sampled through a time window of α samples in path sampling section 251-3. Among delay profiles, parts associated with these sampled non-interfered pilots are temporarily held in delay profile restoring section 260.

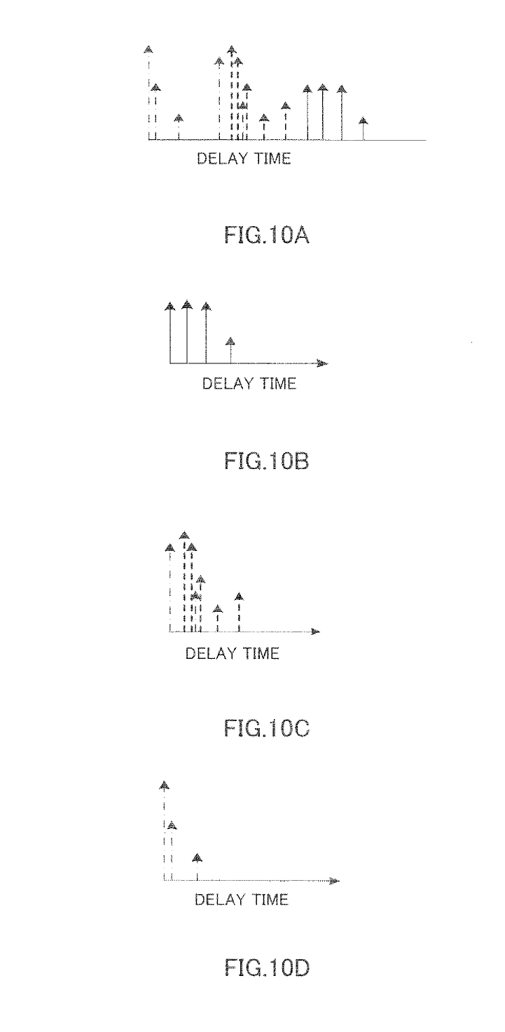

Next, MIMO reception apparatus 200 performs processing of pilots transmitted in the second pilot transmission symbol period. That is, after performing radio receiving processing on received signals and removing the CPs from the received signals, MIMO reception apparatus 200 creates delay profiles in delay profile creating section 240. The delay profile obtained at this time is shown in FIG. 10A, correspond to the paths of pilots transmitted from antenna 4, the arrows indicated by bold dashed lines correspond to the paths of pilots transmitted from antenna 3 and the arrows indicated by alternate long and short dash lines correspond to the paths of pilots transmitted from antenna 5.

Then, the pilots from antenna 4 are sampled through a time window of k samples in path sampling section 251-1 (see FIG. 10B). In addition, the pilots from antenna 3 and antenna 5 are sampled through a time window of k+α samples (see FIG. 10C). Moreover, the non-interfered parts of the pilots from antenna 5 are sampled through a time window of a samples (see FIG. 10D).

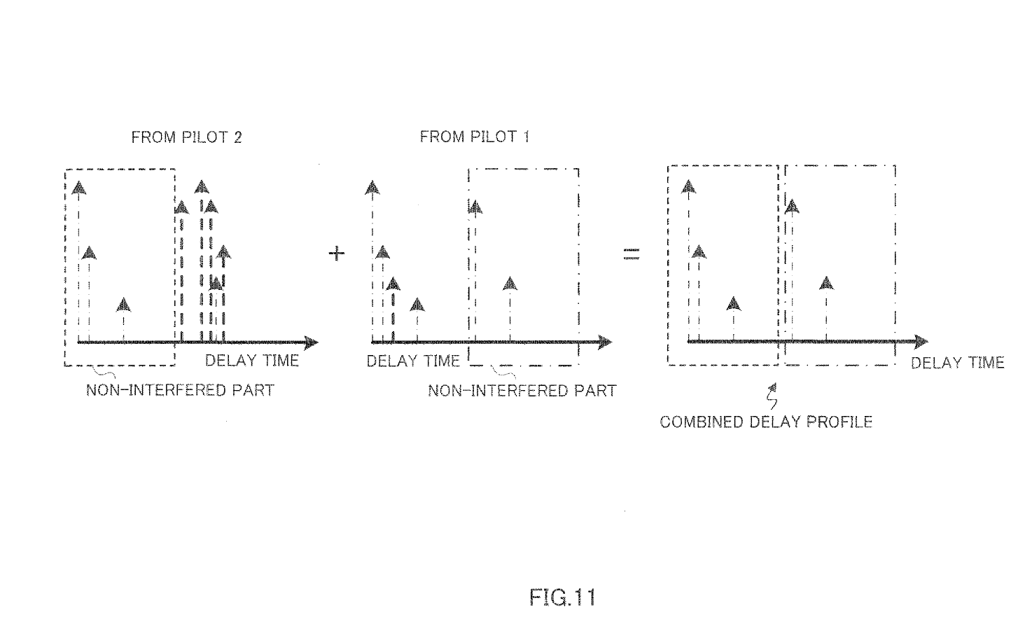

Then, delay profile restoring section 260 combines the held non-interfered part for the first pilot transmission symbol period and the non-interfered part for the second pilot transmission symbol period as shown in FIG. 11. FIG. 11 shows an exemplary case in which α is k/2. In this case, delay profile restoring section 260 connects the partial profiles of the non-interfered parts sampled in both the pilot transmission symbol periods together to form an overall delay profile of non-interfered pilots.

Interfering pilot cancelling section 270 subtracts the delay profile of non-interfered pilots obtained as described above from the delay profile received from path sampling section 251-1 and temporarily held (two delay profiles sampled in both the pilot transmission symbol periods) to acquire a delay profile of non-interfered pilots in both pilot transmission symbol periods.

Then, Fourier transform processing is performed on each pilot in FFT processing section 280. Then, channel estimation value calculating section 290 calculates channel estimation values based on the result of Fourier transform processing.

As described above, according to the present embodiment, MIMO transmission apparatus 100 is provided with a plurality of transmitting antennas 160-1 to 5 that each transmit pilot signal sequences including pilots as part of the sequences in pilot transmission symbol periods, and cyclic shift processing section 140 cyclic-shifts pilot signal sequences to adjust the pilot transmission timings of the plurality of transmitting antennas 160.

Then, MIMO transmission apparatus 100 transmits pilot signal sequences such that part of pilots transmitted from the first transmitting antenna (transmitting antenna 160-5 in the above-described example) overlaps with the pilot transmission symbol period for another transmitting antenna in the first and second pilot transmission symbol periods and this overlapping part of pilots transmitted from the first transmitting antenna (transmitting antenna 160-5 in the above-described example) changes between the first pilot transmission symbol period and the second pilot transmission symbol period.

By this means, interfering pilots can be transmitted with partially overlapping with other pilot transmission periods, so that each remaining sample time domain shorter than a pilot length can be effectively utilized. Then, when interfering pilots are transmitted, non-interfered parts (parts other than the above-described overlapping part in interfering pilots) change between pilot transmission symbol periods, so that it is possible to reproduce an overall delay profile of interfering pilots by sampling partial delay profiles of non-interfered pilots in the delay profiles of pilots transmitted in both pilot transmission symbol periods and combining them on the receiving side. Moreover, also it is possible to reproduce delay profiles of interfered pilots by subtracting the acquired delay profiles of interfering pilots from the delay profiles of interfered pilots subjected to interference from interfering pilots. That is, it is possible to provide MIMO transmission apparatus 100 allowing efficient pilot transmission utilizing remaining samples present in pilot symbols while maintaining the accuracy of pilot separation on the receiving side.

### Embodiment 2

With the present embodiment, the method of combining partial delay profiles, performed by the delay profile restoring section, when particularly Ε is k/2 or above and less than k, will be described. Here, the configuration of the MIMO reception apparatus according to the present embodiment is the same as in embodiment 1, and will be explained using the configuration block diagram of FIG. 5.

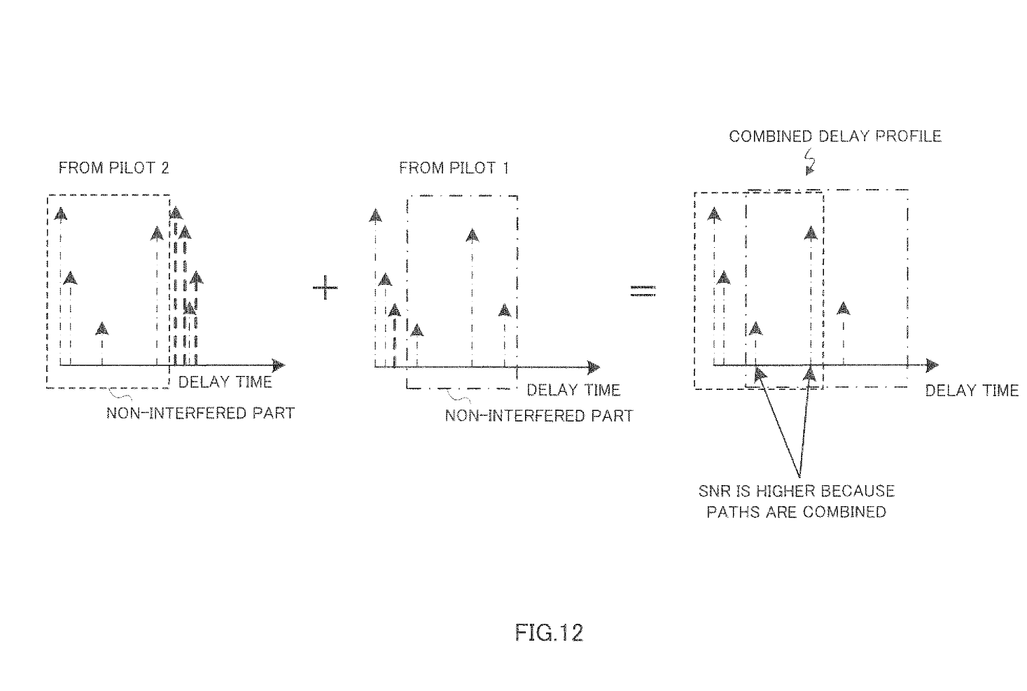

Delay profile restoring section 260 combines the non-interfered part in the first pilot transmission symbol period and the non-interfered part in the second pilot transmission symbol period as shown in FIG. 12.

That is, first, delay profile restoring section 260 adjusts respective reference positions of the partial delay profiles of the non-interfered parts, which are sampled in the first and second pilot transmission symbol periods. Here, temporal spread of each partial delay profile is k/2 or above, so that the partial delay profile sampled in the first transmission symbol period and the partial delay profile sampled in the second transmission symbol period partially overlap.

Then, delay profile restoring section 260 forms an overall delay profile of non-interfered pilots by adding up peaks occurring in the same position. Thus, it is possible to improve SNR (Signal to Noise Ratio) by adding up peaks to form an overall delay profile of interfering pilots. As a result of this, channel estimation values can be calculated more accurately.

### Embodiment 3

With the present embodiment, MIMO transmission apparatus switches transmitting antennas that transmit interfering pilots per frame. Here, the configuration of the MIMO transmission apparatus according to the present embodiment is the same as embodiment 1, and will be explained using the configuration block diagram in FIG. 4.

Pilot transmission control section 170 switches transmitting antennas for transmitting interfering pilots by changing contents of transmission control information and cyclic shift control information outputted to switch section 120 and cyclic shift processing section 140.

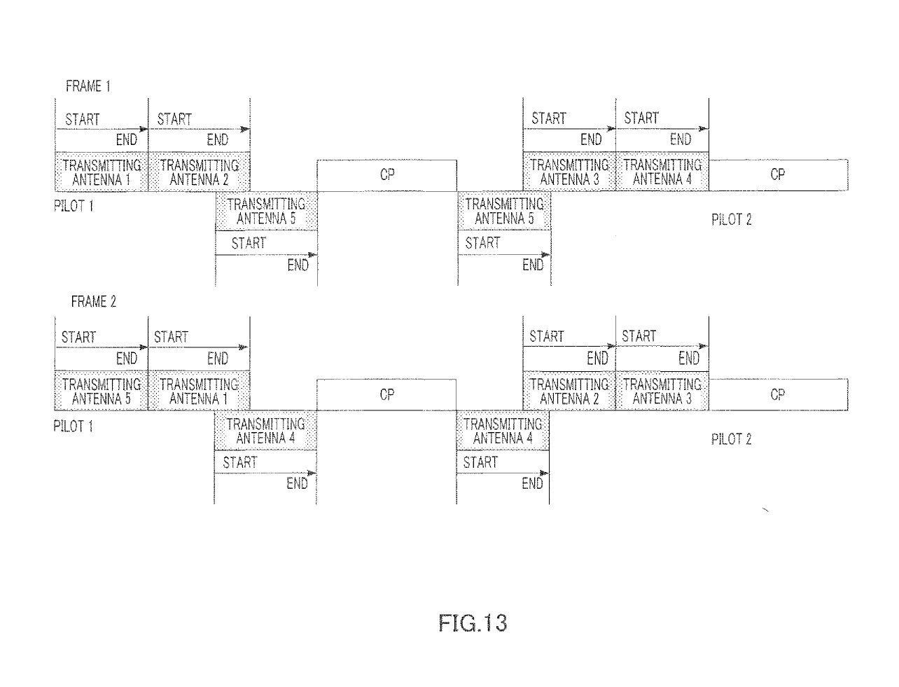

For example, as shown in FIG. 13, pilot transmission control section 170 transmits pilots transmitted from antenna 5 as interfering pilots in frame 1 and transmits pilots transmitted from antenna 4 as interfering pilots in frame 2.

In addition, pilot transmission control section 170 switches antennas for transmitting non-interfered pilots and interfered pilots along with the switching of antennas for transmitting interfering pilots. Moreover, when pilots are transmitted, pilot transmission control section 170 changes pilots between the first and second pilot transmission symbol periods.

In FIG. 13, first, transmitting antenna 160-5 transmits an interfering pilot in frame 1, and when the antenna for transmitting interfering pilots is switched to transmitting antenna 160-4, transmits a non-interfered pilot at the beginning of the first pilot transmission symbol period. In addition, transmitting antenna 160-1 transmits an interfered pilot in the first pilot transmission symbol period in frame 2.

Moreover, transmitting antenna 160-3 transmits a pilot in the first transmission symbol period in frame 1 and transmits a pilot for the second pilot transmission symbol period in frame 2.

As described above, according to the present embodiment, MIMO transmission apparatus 100 switches transmitting antennas for transmitting interfering pilots per frame by control through pilot transmission control section 170.

By this means, it is possible to equalize the accuracy of calculating channel estimation values on the receiving side. That is, as described with embodiment 2, when the MIMO reception apparatus on the receiving side adds up peaks to form an overall delay profile of interfering pilots (in this time, the condition is satisfied that α is k/2 or above and less than k), the SNR for an interfering pilot is higher than other pilots. Therefore, it is possible to improve the SNR equally for all transmitting antennas by switching transmitting antennas for transmitting interfering pilots in a predetermined cycle without fixing.

In addition, MIMO transmission apparatus 100 also switches transmitting antennas for transmitting non-interfered pilots and interfered pilots besides interfering pilots by control through pilot transmission control section 170.

By this means, the SNR for transmitting antennas can be further equalized.

The disclosure of Japanese Patent Application No. 2007-318748, filed on Dec. 10, 2007, including the specification, drawings and abstract, is incorporated herein by reference in its entirety.

### INDUSTRIAL APPLICABILITY

The pilot transmission method, the MIMO transmission apparatus and the MIMO reception apparatus according to the present invention are useful to allow efficient pilot transmission utilizing remaining samples present in pilot symbols while maintaining the accuracy of pilot separation on the receiving side.

1. A method of transmitting pilots in a multiple-input/multiple-output transmission apparatus that transmits pilots from a plurality of transmitting antennas, the method comprising the steps of:
generating pilot signal sequences including the pilots as part of the sequences; and
transmitting the pilot signal sequences with the pilots at transmission timings shifted between the plurality of transmitting antennas by cyclic-shifting the pilot signal sequences in each pilot transmission symbol period,
wherein the transmission timings of the pilots differ between a first pilot transmission symbol period and a second pilot transmission symbol period.

2. The method of transmitting pilots according to claim 1, wherein part of pilots transmitted from a first transmitting antenna overlaps with pilots transmitted from other transmitting antennas, and the part change between the first and second pilot transmission symbol periods in which the pilots are transmitted from the first transmitting antenna.

3. The method of transmitting pilots according to claim 2, wherein an antenna selected as the first transmitting antenna differs per frame.

4. The method of transmitting pilots according to claim 2, wherein antennas selected as the other transmitting antennas differ between the first and second pilot transmission symbol periods.

5. A multiple-input/multiple-output transmission apparatus comprising:
a plurality of transmitting antennas that transmit pilot signal sequences including pilots as part of the sequences in pilot transmission symbol periods, respectively; and
a pilot transmission section that comprises a cyclic shift section which shifts transmission timings of the pilots between the plurality of transmitting antennas for cyclic-shifting the pilot signal sequences, and selects transmitting antennas for the pilot signal sequences for each pilot transmission symbol period,
wherein the pilot transmission section changes the transmission timings of the pilots between a first pilot transmission symbol period and a second pilot transmission symbol period.

6. The Multiple-input/multiple-output transmission apparatus according to claim 5, wherein the pilot transmission section transmits the pilots with partially overlapping with pilot transmission symbol periods for other transmitting antennas, from a first transmitting antenna in the first and second pilot transmission symbol periods, and changes an overlap part of the pilots transmitted from the first transmitting antenna between the first and second pilot transmission symbol periods.

7. The Multiple-input/multiple-output transmission apparatus according to claim 6, wherein an antenna selected as the first transmitting antenna differs per frame.

8. The multiple-input/multiple-output transmission apparatus according to claim 6, wherein antennas selected as the other transmitting antennas differ between the first and second pilot transmission symbol periods.

9. A multiple-input/multiple-output reception apparatus that receives a first pilot symbol and a second pilot symbol transmitted such that interfering parts of pilots transmitted from a first transmitting antenna with overlap with transmission periods for pilots transmitted from other transmitting antennas other than the first transmitting antenna change between a first pilot transmission symbol period and a second pilot transmission symbol period, the multiple-input/multiple-output reception apparatus comprising:
a delay profile creating section that creates a first delay profile and a second delay profile from the first pilot symbol and the second pilot symbol received;
a delay profile reproducing section that samples, in the first and second delay profiles, first and second partial delay profiles corresponding to non-interfered parts of the pilots transmitted from the first transmitting antenna, and combines the first and second partial delay profiles to form a combined delay profile;
a calculating section that subtracts the combined delay profile from the delay profiles; and
a channel estimation value calculating section that calculates a channel estimation value based on the combined delay profile and a subtraction result in the calculating section.
